(19) United States
(12) Patent Application Publication
(10) Pub. No.: US 2009/0142001 A1
(43) Pub. Date: Jun. 4, 2009

(54) IMAGE COMPOSING APPARATUS

(75) Inventor: Osamu KUNIYUKI, Gifu (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: Sanyo Electric Co., Ltd., Osaka (JP)

(21) Appl. No.: 12/324,356

(22) Filed: Nov. 26, 2008

(30) Foreign Application Priority Data
Nov. 30, 2007 (JP) 2007-309641
Nov. 30, 2007 (JP) 2007-309675

(51) Int. Cl. G06K 9/36

(52) U.S. Cl. 382/284

(57) ABSTRACT

An image composing apparatus includes a flash memory and an I/F for accessing a recording medium. A plurality of template images are contained in the flash memory, and a photographed image is contained in the recording medium via the I/F. An attribute (attribute: center coordinates and a size) of a transparent area frame provided in each of the plurality of template images is detected by a CPU. An attribute of a face frame provided in the photographed image is also detected by the CPU. The CPU calculates each of composition matching levels of the plurality of template images based on the detected attributes of the transparent area frame and the face frame, and designates each of the plurality of template images in order of decreasing calculated composition matching level. Further, the CPU composes the designated template image and photographed image in such a manner tot the composition matching level increases.

### CROSS REFERENCE OF RELATED APPLICATION

The disclosures of Japanese Patent Application No. 2007-309641 and No. 2007-309675 which were filed on Nov. 30, 2007 are incorporated herein by reference.

### BACKGROUND OF THE INVENTION

1. Field of the Invention

The present invention relates to an image composing apparatus for creasing a composite image by multiplexing a predetermined image onto a photographed image.

The present invention relates also to an image composing apparatus for creating a composite image by multiplexing a predetermined image having a plurality of transparent areas onto a photographed image.

2. Description of the Related Art

According to this type of a certain apparatus (1), upon producing a composite image, a plurality of material images are firstly arranged on a background image, and subsequently, a trimming process in which a template trimming mask selected randomly is used is executed on each material image. Thereafter, “levels of attractiveness” are calculated for all the plurality of material images, and unless the level of attractiveness of a specific material image is remained within lower several ranks, the trimming process is executed again. The trimming process is repeated until the level of attractiveness of a specific material image is remained within the lower several ranks, and therefore, a composite image in which a thrill featured in a game or amusement is added is completed.

However, in the above-described apparatus (1), even though a shape of the template trimming mask allotted to the material image is adjusted based on the level of attractiveness, relative sizes/positions of the material image and the template trimming mask are not adjusted based on the level of attractiveness. Thus, in the above-described apparatus (1), there is a limit to a quality of the composite image.

Further, according to this type of another apparatus (2), an overlapped image is composed on inputted video from an image input device. The inputted video represents an upper body of a person and a background. The overlapped image has a face-use transparent region for displaying a face of a person even after the composition, a facial circumference-use non-transparent region for masking or decorating an outline of the face, and a background-use transparent region for displaying a background after the composition. In the composite image created by composing the overlapped image onto the inputted video, the facial circumference-use non-transparent region of which the position is shifted in alignment with the position of the face of a person is displayed, the face is displayed by penetrating through the face-use transparent region, and the background is displayed by penetrating through the background-use transparent region.

According to the apparatus (2), although the overlapped image has the two transparent regions, allotting of a target object that is to penetrate through a transparent region is previously determined, and the transparent region through which the face of a person is caused to penetrate cannot be changed between the two transparent regions. In addition, a relative position between the face-use transparent region and the face cannot be changed, either, after the composite image is created. Thus, in the above-described apparatus (2), there is a limit to a quality of the composite image.

### SUMMARY OF THE INVENTION

An image composing apparatus according to the present invention, comprises: a first detector for detecting an attribute of a transparent area provided in each of M (M: an integer of equal to or more than two) of predetermined images; a second detector for detecting an attribute of a specific object image provided in a photographed image; a calculator for calculating a composition matching level equivalent to smallness of a difference between each of M of attributes detected by the first detector and the attribute detected by the second detector, a designator for designating one of M of the predetermined images in order of decreasing composition matching level calculated by the calculator; and a first composer for composing the predetermined image designated by said designator and the photographed image.

Preferably, the first detector includes a first position detector for detecting a position of the transparent area as a portion of the attribute, the second detector includes a second position detector for detecting a position of the specific object image as a portion of the attribute, and the calculator increases the composition matching level as a difference between the position detected by the first position detector and the position detected by the second position detector is smaller.

In an aspect of the present invention, further comprises is a rotator for rotating the photographed image so that a specific object stands upright, wherein the calculator notices a position of the specific object image after being rotated by the rotator.

In another aspect of the present invention, each of M of the predetermined images has one or more transparent areas, the first detector further includes a first size detector for detecting each of sizes of the one or more transparent areas, as another portion of the attribute, and the first position detector executes a position detecting process for a transparent area having a size satisfying a size condition, out of the sizes detected by the first size detector.

In an embodiment of the present invention, the second detector further includes a second size detector for detecting a size of the specific object image, as another portion of the attribute, and the size condition includes a condition under which a difference from the size detected by the second detector is the smallest.

Preferably, further comprised are an extractor for extracting a predetermined image having a time-of-year setting, out of N (N: an integer of equal to or more than M) of predetermined images; and an excluder for excluding a predetermined image having a time-of-year setting not matching a date of the photographed image, out of the predetermined images extracted by the extractor, wherein the predetermined images remained after an excluding process of the excluder, out of N of the predetermined images, are equivalent to the M of the predetermined images.

More preferably, the designator includes a first allocator for allocating an order according to the composition matching level to the predetermined image having a time-of-year setting, and a second allocator for allocating to the predetermined image not having a time-of-year setting an order according to the composition matching level and lower than the order allocated by the first allocator.

Preferably, the designator includes an updater for updating the predetermined image composed by the first composer at each time an image updating operation is accepted.

Preferably, the first composer includes a magnification adjuster for adjusting a magnification of the photographed image so that a size of the specific object image becomes close to a size of the transparent area, and a position adjuster for adjusting a composition position so that a position of the transparent area becomes close to a position of the specific object image.

More preferably, further comprised are a first magnification corrector for correcting a magnification of the photographed image in response to a magnification correcting operation; a first position corrector for correcting the composition position in response to a position correcting operation; and a second composer for composing again the predetermined image designated by the designator and the photographed image by referring to a correction result of the first magnification corrector and/or the first position corrector.

In an aspect of the present invention, further comprised is a magnification correction amount normalizer for normalizing a magnification correction amount by the first magnification corrector based on a size of the transparent area on the predetermined image designated by the designator, wherein the first composer further includes a second magnification corrector for correcting the magnification of the photographed image based on the size of the transparent area on the predetermined image designated by the designator and the magnification correction amount normalized by the magnification correction amount normalizer.

In another aspect of the present invention, further comprised is a position correction amount normalizer for normalizing the position correction amount by the first position corrector based on the size of the transparent area on the predetermined image designated by the designator, wherein the first composer further includes a second position corrector for correcting the composition position based on the size of the transparent area on the predetermined image designated by the designator and the position correction amount normalized by the position correction amount normalizer.

Preferably, further comprised is a clipper for clipping one portion of the photographed image that sticks out from an outer edge of the predetermined image composed by the first composer.

Preferably, the specific object image is equivalent to a lace image.

Preferably, further comprised are an acceptor for accepting an image selection operation for selecting the photographed image to be noticed by the first detector; and an issuer for issuing a warning when the photographed image selected by the image selection operation does not have the specific object image.

Preferably, the first composer executes a composing process in such a manner that the composition matching level calculated by the calculator increases.

According to the present invention, an image composition program product executed by a processor of an image composing apparatus, the image composition program product, comprises: a first detecting step of detecting an attribute of a transparent area provided in each of M (M: an integer of equal to or more than two) of predetermined images; a second detecting step of detecting an attribute of a specific object image provided in a photographed image; a calculating step of calculating a composition matching level equivalent to smallness of a difference between each of M of attributes detected by the first detecting step and the attribute detected by the second detecting step; a designating stop of designating one of M of the predetermined images in order of decreasing composition matching level calculated by the calculating step; and a composing step of composing the predetermined image designated by the designating step and the photographed image.

According to the present invention, an image composing method executed by an image composing apparatus, the image composing method, comprises: a first detecting step of detecting an attribute of a transparent area provided in each of M (M: an integer of equal to or more than two) of predetermined images; a second detecting step of detecting an attribute of a specific object image provided in a photographed image; a calculating step of calculating a composition matching level equivalent to smallness of a difference between each of M of attributes detected by the first detecting step and the attribute detected by the second detecting step; a designating step of designating one of M of the predetermined images in order of decreasing composition matching level calculated by the calculating step; and a composing step of composing the predetermined image designated by the designating step and the photographed image.

An image composing apparatus according to the present invention, comprises: a first detector for detecting an attribute of each of a plurality of transparent areas provided on a predetermined image; a second detector for detecting an attribute of a specific object image provided in a photographed image; a calculator for calculating a difference between each of the plurality of attributes detected by the first detector and the attribute detected by the second detector; a selector for selecting one of the plurality of transparent areas based on the difference calculated by the calculator, and a first composer for composing the predetermined image and the photographed image in such a manner that the difference between the attribute of the transparent area selected by the selector and the attribute of the specific object image is inhibited.

Preferably, the selector selects a transparent area in which the difference is small.

In an aspect of the present invention, the first detector detects, as the attribute, a size of each of the plurality of transparent areas, the second detector detects, as the attribute, a size of the specific object image, and the calculator calculates a difference between the size of each of the transparent areas and the size of the specific object image.

In another aspect of the present invention, the first composer includes a magnification adjustor for adjusting a magnification of the photographed image so that a size of the specific object image becomes close to a size of the transparent area, and a position adjustor for adjusting a composition position so that a position of the transparent area becomes close to a position of the specific object image.

More, preferably, further comprised are a first magnification corrector for correcting the magnification of the photographed image in response to a magnification correcting operation; a first position corrector for correcting the composition position in response to a position correcting operation; and a second composer for composing again the predetermined image designated by the designator and the photographed image by referring to a correction result of the first magnification corrector and/or the first position corrector.

In an embodiment of the present invention, further comprised is a magnification correction amount normalizer for normalizing a magnification correction amount by the first magnification corrector based on a size of the transparent area on the predetermined image designated by the (designator, wherein the first multiplexer further includes a second magnification corrector for correcting the magnification of the photographed image based on the size of the transparent area on the predetermined image designated by the designator and the magnification correction amount normalized by the magnification correction amount normalizer.

In another embodiment of the present invention, further comprised is a position correction amount normalizer for normalizing the position correction amount by the first position corrector based on the size of the transparent area on the predetermined image designated by the designator, wherein the first multiplexer further includes a second position corrector for correcting the composition position based on the size of the transparent area on the predetermined image designated by the designator and the position correction amount normalized by the position correction amount normalizer.

Preferably, further comprised is a clipper for clipping one portion of the photographed image that sticks out from an outer edge of the predetermined image composed by the first composer.

Preferably, the specific object image is equivalent to a face image.

According to the present invention, an image composition program product executed by a processor of an image composing apparatus, the image composition program product, comprises: a first detecting step of detecting an attribute of each of a plurality of transparent areas provided on a predetermined image; a second detecting step of detecting an attribute of a specific object image provided in a photographed image; a calculating step of calculating a difference between each of the plurality of attributes detected by the first detecting step and the attribute detected by the second detecting step; a selecting step of selecting one of the plurality of transparent areas based on the difference calculated by the calculating step; and a composing step of composing the predetermined image and the photographed image in such a manner that the difference between the attribute of the transparent area selected by the selector and the attribute of the specific object image is inhibited.

According to the present invention, an image composing method executed by an image composing apparatus, the image composing method, comprises: a first detecting step of detecting an attribute of each of a plurality of transparent areas provided on a predetermined image; a second detecting step of detecting an attribute of a specific object image provided in a photographed image; a calculating step of calculating a difference between each of the plurality of attributes detected by the first detecting step and the attribute detected by the second detecting step; a selecting step of selecting one of the plurality of transparent areas based on the difference calculated by the calculating step; and a composing step of composing the predetermined image and the photographed image in such a manner that the difference between the attribute of the transparent area selected by the selector and the attribute of the specific object image is inhibited.

An image composing apparatus according to the present invention, comprises: a calculator for calculating a composing process parameter based on an attribute of a specific object image owned by a photographed image and an attribute of a transparent area provided on a predetermined image; a first composer for composing the predetermined image and the photographed image based on the composing process parameter calculated by the calculator and a correction coefficient; an updater for updating the correction coefficient in response to a correcting operation after a process of the first composer is completed; a second composer for composing again the predetermined image and the photographed image in such a manner as to follow the correcting operation; and a restarter for restarting the calculator by updating the predetermined image when an image updating operation is accepted.

Preferably, the calculator calculates the composing process parameter so that a difference between the attribute of the transparent area and the attribute of the specific object image is inhibited.

Preferably, the first composer includes a corrector for correcting the composing process parameter based on the correction coefficient.

Preferably, the composing process parameter includes a magnification and a composition position of the photographed image, the correcting operation includes a magnification correcting operation for correcting the magnification and a composition position correcting operation for correcting the composition position, and the correction coefficient includes a magnification correction coefficient and a composition position correction coefficient.

The above described features and advantages of the present invention will become more apparent from the following detailed description of the embodiment when taken in conjunction with the accompanying drawings.

### BRIEF DESCRIPTION OF THE DRAWINGS

FIG. 1 is a block diagram showing a configuration of one embodiment of the present invention;

FIG. 2 is an illustrative view showing one example of a mapping state of an SDRAM applied to the embodiment in FIG. 1;

FIG. 3 is an illustrative view showing one example of a structure of a JPEG file containing a photographed image;

FIG. 4 is an illustrative view showing one example of a structure of a JPEG file containing a template image:

FIG. 5(A) is an illustrative view showing one example of a photographed image;

FIG. 5(B) is an illustrative view showing another example of the photographed image;

FIG. 6(A) is an illustrative view showing one example of a template image;

FIG. 6(B) is an illustrative view showing another example of the template image;

FIG. 6(C) is an illustrative view showing still another example of the template image;

FIG. 6(D) is an illustrative view showing yet still another example of the template image;

FIG. 7(A) is an illustrative view showing one example of a template image extracting process operation;

FIG. 7(B) is an illustrative view showing another example of the template image extracting process operation;

FIG. 8(A) is an illustrative view showing one example of a photographed image selected for an image composing process;

FIG. 8(B) is an illustrative view showing one example of a template image selected for an image composing process;

FIG. 8(C) is an illustrative view showing one example of a transparent area frame and a face frame, detected from a template image and a photographed image, respectively;

FIG. 8(D) is an illustrative view showing one example of the face frame;

FIG. 8(E) is an illustrative view showing one example of an arrangement of a transparent area frame and a face frame;

FIG. 8(F) is an illustrative view showing one example of a multiplex state of the template image onto the photographed image;

FIG. 8(G) is an illustrative view showing one example of a composite image;

FIG. 9(A) is an illustrative view showing another example of an arrangement of the transparent area frame and the face frame;

FIG. 9(B) is an illustrative view showing another example of the composite image;

FIG. 9(C) is an illustrative view showing another example of the template image selected for the image composing process;

FIG. 9(D) is an illustrative view showing one example of an arrangement of a transparent area frame and a face frame;

FIG. 9(E) is an illustrative view showing another example of the arrangement of the transparent area frame and the face frame;

FIG. 9(F) is an illustrative view showing another example of the composite image;

FIG. 9(G) is an illustrative view showing still another example of the composite image;

FIG. 10(A) is an illustrative view showing one example of a photographed image selected for an image composing process;

FIG. 10(B) is an illustrative view showing one example of a template image selected for the image composing process;

FIG. 10(C) is an illustrative view showing one example a transparent area frame and a face frame, detected from the template image and the photographed image, respectively;

FIG. 10(D) is an illustrative view showing one example of the race frame;

FIG. 10(E) is an illustrative view showing one example of an arrangement of the transparent area frame and the face frame;

FIG. 10(F) is an illustrative view showing one example of a multiplex state of the template image onto the photographed image;

FIG. 10(G) is an illustrative view showing one example of the composite image;

FIG. 11(A) is an illustrative view showing another example of the arrangement of the transparent area frame and the enlarged face frame;

FIG. 11(B) is an illustrative view showing another example of the composite image;

FIG. 11(C) is an illustrative view showing another example of the template image selected for the image composing process;

FIG. 11(D) is an illustrative view showing one example of an arrangement of the transparent area frame and the face frame;

FIG. 11(E) is an illustrative view showing another example of the arrangement of the transparent area frame and the face frame;

FIG. 11(F) is an illustrative view showing another example of the composite image;

FIG. 11(G) is an illustrative view showing still another example of the composite image;

FIG. 12 is a flowchart showing one portion of an operation of a CPU applied to the embodiment in FIG. 1;

FIG. 13 is a flowchart showing another portion of the operation of the CPU applied to the embodiment in FIG. 1;

FIG. 14 is a flowchart showing still another portion of the operation of the CPU applied to the embodiment in FIG. 1;

FIG. 15 is a flowchart showing yet still another portion of the operation of the CPU applied to the embodiment in FIG. 1;

FIG. 16 is a flowchart showing another portion of the operation of the CPU applied to the embodiment in FIG. 1; and

FIG. 17 is a flowchart showing still another portion of the operation of the CPU applied to the embodiment in FIG. 1.

### DETAILED DESCRIPTION OF THE PREFERRED EMBODIMENTS

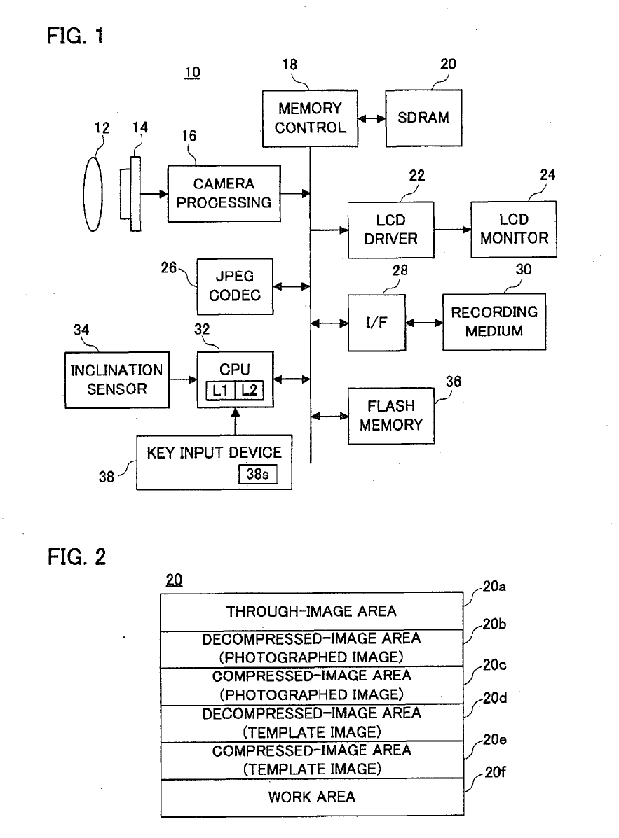

With reference to FIG. 1, a digital camera 10 according to this embodiment includes an optical lens 12. An optical image representing an object scene is irradiated onto a light receiving surface of an imaging device 14 through the optical lens 12. On the light receiving surface, electric charges representing the object scene image are produced by a photoelectronic conversion.

When a camera mode is selected by a key input device 38, a CPU 32 instructs the imaging device 14 to repeatedly perform pre-exposure and thinning-out reading in order to execute a through-image process. The imaging device 14 performs the pre-exposure on the light receiving surface at each generation of a vertical synchronization signal Vsync, and also reads out one portion of the electric charges produced by this pre-exposure in a raster scanning manner from the light receiving surface. The vertical synchronization signal Vsync is outputted at each 1/30 seconds, and as a result, a low-resolution raw image signal representing the object scene is outputted from the imaging device 14 at a frame rate of 30 fps.

A camera processing circuit 16 performs processes, such as A/D conversion, white balance adjustment, YUV conversion, on the raw image signal outputted from the imaging device 14 to create image data in a YUV format. The created image data is written to a through-image area 20a (see FIG. 2) of an SDRAM 20 through a memory control circuit 18. An LCD driver 22 reads out the image data accommodated in the through-image area 20a at each 1/30 seconds, and drives an LCD monitor 24 based on the read-out image data of each frame. As a result, a real-time moving image that represents the object scene, i.e., a through-image, is displayed on the monitor screen.

When a shutter button 38s on the key input device 38 is half-depressed, the CPU 32 fetches posture information outputted from an inclination sensor 34. The fetched posture information is written to a work area 20f of the SDRAM 20 through the memory control circuit 18.

The CPU 32 further executes a face recognizing process based on the output from the camera processing circuit 16 in response to the half-depression of the shutter button 38s. When a face of a person is present in the object scene, the number of faces, center coordinates and a size of a face frame surrounding each lace are detected by the face recognizing process. Furthermore, when a plurality of faces are present, a segment indicating “primary” is assigned to any one of the faces, and segments indicting “secondary” are assigned to the remaining faces. Such face information is also written to the work area 20f of the SDRAM 20 through the memory control circuit 18. It is noted that date information of today, detected by a clock circuit not shown, is also written to the work area 20f.

When the shutter button 38s is full-depressed, the CPU 32 instructs the imaging device 14 to execute the primary exposure and the all-pixel reading once each. The imaging device 14 performs the primary exposure on the light receiving surface, and reads out all the electric charges produced by the primary exposure from the light receiving surface in a raster scanning manner. As a result, a high-resolution raw image signal representing the object scene is outputted form toe imaging device 14.

One frame of the outputted raw image signal is subjected to a process similar to that described above by the camera processing circuit 16. Image data in a YUV format created by the camera processing circuit 16 is written to a decompressed-image area 20b of the SDRAM 20 through the memory control circuit 18.

The CPU 32 further applies a compression instruction and a recording instruction to a JPEG codec 26 and an VF circuit 28, respectively, in response to the full depression of the shutter button 38s. The JPEG codec 26 reads out the image data accommodated in the decompressed-image area 20b through the memory control circuit 18, performs a JPEG compression on the read-out image data, and writes the compressed image data, i.e., JPEG data, to a compressed-image area 20c of the SDRAM 20 through the memory control circuit 18.

The I/F circuit 28 reads out the JPEG data from the compressed-image area 20c through the memory control circuit 18, and accommodates the read-out JPEG data in a JPEG file created in a recording medium 30. The I/F circuit 28 further reads out the posture information, the lace information, and (he date information from the work area 20f through the memory control circuit 18, and embeds tag data written with these information in a header of the same JPEG file. Upon completion of such a recording process, the above-described through-image process is resumed.

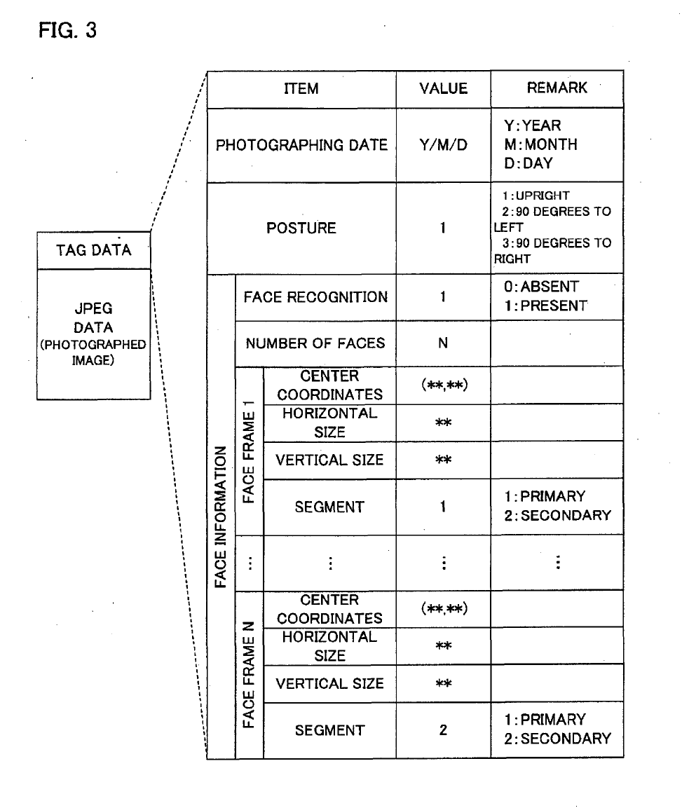

The JPEG file containing a photographed image is configured as shown in FIG. 3. The tag information is configured by the date information, the posture information, and the face information, as described above. The date information is represented by year, month, and day. The posture information is represented by any one of “1”, “2” and “3”, which mean an upright state, a 90-degree-rotated-to-left state, and a 90-degree-rotated-to-right state, respectively. The face information is specifically configured by face recognition information, face count information, and face frame information. With respect to the face recognition information, “0” indicates that the face is not present, and “1” indicates that the face is present. With respect to the face count information, a numerical value N corresponds to the number of faces. The face frame information includes: center coordinates of each face frame; horizontal/vertical sizes thereof, and a segment of each face. The segment of the primary face is set to “1”, and the segment of the secondary face is set to “2”. It is noted that a primary-and-secondary relationship of the face is determined, for example, by a level of smile, a size of a face, etc.

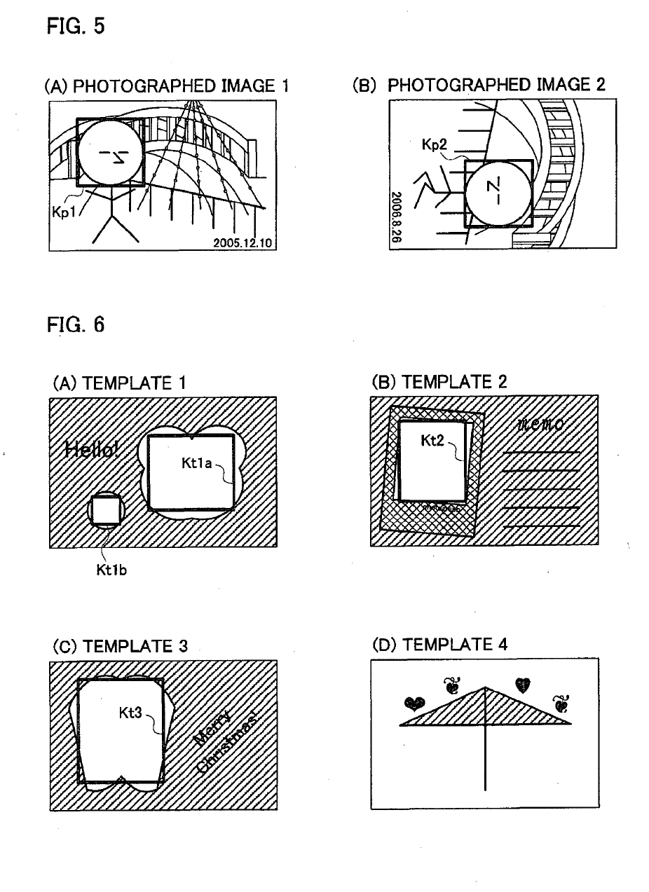

The JPEG data represents a photographed image shown in FIG. 5(A) or FIG. 5(B), for example. According to FIG. 5(A), the object scene is photographed in the upright state on Dec. 10, 2005, and a single face image is present at an upper left side of the object scene. A face frame Kp1 is defined so as to surround this face image. According to FIG. 5(B), the object scene is captured in the 90-degree-rotated-to-left state on Aug. 26, 2006, and a single face image is present on a right side of the object scene. A face frame Kp2 is defined so as to surround this face image.

When a reproduction mode is selected by the key input device 38 and a desired JPEG file is designated, the CPU 32 applies a reproduction instruction and a decompression instruction to the I/F circuit 28 and the JPEG codec 26, respectively. In the reproduction instruction, an identification number of the desired JPEG file is written.

The I/F circuit 28 reads out JPEG data accommodated in the desired JPEG file from the recording medium 30, and writes the read-out JPEG data to the compressed-image area 20c of the SDRAM 20 through the memory control circuit 18. The JPEG codec 26 reads out the JPEG data accommodated in the compressed-image area 20c through the memory control circuit 18, performs JPEG decompression on the read-out JPEG data, and writes the decompressed image data to the decompressed-image area 20b of the SDRAM 20 through the memory control circuit 18.

The LCD driver 22 reads out the decompressed image data accommodated in the decompressed-image area 20b through the memory control circuit 18, and drives the LCD monitor 24 based on the read-out decompressed image data. As a result, the photographed image is displayed on the monitor screen.

When an image updating operation is performed on the key input device 38, the reproduction instruction and the decompression instruction are issued again. The identification number written in the reproduction instruction indicates a subsequent JPEG file, and as a result, the photographed image accommodated in the subsequent JPEG file is outputted from the LCD monitor 24.

The digital camera 10 of this embodiment has an image composition mode for composing a template image onto a recorded photographed image. The template image is prepared in a flash memory 36 (may also be in the recording medium 30) in a JPEG file format, and the JPEG file is configured by tag data and JPEG data as in the above description.

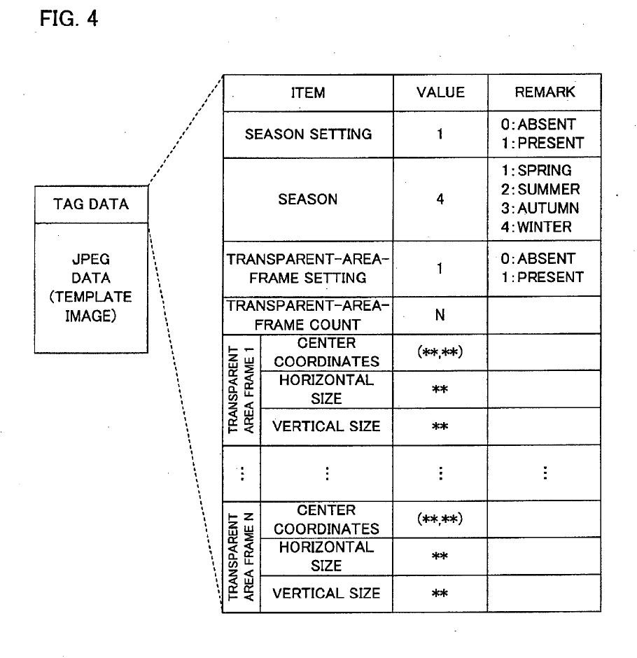

In the tag data, there are written season setting information, season information, transparent-area-frame setting information, transparent-area-frame count information, and transparent-area-frame information, as shown in FIG. 4. With respect to the season setting information, “0” indicates that no season setting is present, and “1” indicates that the season setting is present. With respect to the season information, “1” indicates spring, “2” indicates summer, “3” indicates autumn, and “4” indicates winter. With respect to the transparent-area-frame setting information, “0” indicates that no transparent area frame setting is present, and “1” indicates that the transparent airframe setting is present. With respect to the transparent-area-frame count information, N indicates the number of transparent area frames. The transparent-area-frame information includes center coordinates and horizontal/vertical sizes of each of the transparent area frames.

The JPEG data represents a template image shown in FIG. 6(A), FIG. 6(B), FIG. 6(C), or FIG. 6(D), for example. In any one of FIG. 6(A) to FIG. 6(D), a white area corresponds to the transparent area.

With respect to the template image shown in FIG. 6(A), no season setting is present, and two transparent area frames Kt1a and Kt1b are respectively arranged on the two transparent areas. With respect to the template image shown in FIG. 6(B), no season setting is present, and a single transparent area frame Kt2 is arranged on the single transparent area.

With respect to the template image shown in FIG. 6(C), the season setting is present, and the season information indicates the winter. Furthermore, a single Transparent area frame Kt3 is arranged on the single transparent area. With respect to the template image shown in FIG. 6(D), neither season setting nor transparent area frame are present. When the transparent area extends to an outer edge of the template image as shown in FIG. 6(D), the transparent area frame is defined as “non-setting”.

When the image composition mode is selected, a JPEG file recorded in the recording medium 30 is firstly reproduced according to the above-described manner to display the photographed image on the LCD monitor 24. Furthermore, when a photographed-image updating operation is performed, the photographed image displayed on the LCD monitor 24 is updated. When a selecting operation is performed on the key input device 38 in a state that the desired photographed image is displayed, it is determined based on the writing of the tag data whether or not the photographed image which is being displayed has a face image. Unless the face image is present, a warning for prompting the image updating operation is outputted.

On the other hand, if the face image is present, the posture of the object scene is determined based on the writing of the tag data. The photographed image is developed in the work area 20f such that the object scene stands upright. Therefore, when the photographed image shown in FIG. 5(A) is selected, the photographed image is developed in the work area 20f as it is. On the other hand, when the photographed image shown in FIG. 5(B) is selected, this photographed image is developed in the work area 20f in a state of being rotated by 90 degrees to the left. Hereafter, the photographed image developed in the work area 20f is defined as a “noticeable photographed image”, and a primary face frame on the noticeable photographed image is defined as a “noticeable face frame”.

Subsequently, the template images having the transparent area frame are extracted on a list L1. It is noted that out of the template images having the season setting, the template image of which the season does not agree with a photographing date is excluded from an extracted target.

A date of the photographed image shown in FIG. 5(A) is Dec. 10, 2005, and a date of the photographed image shown in FIG. 5(B) is Aug. 26, 2006. On the other hand, the template images raving the transparent area frame are those shown in FIG. 6(A) to FIG. 6(C), and out of these images, the template image having the season setting is that shown in FIG. 6(C). In addition, the season information of the template image shown in FIG. 6(Q is the winter.

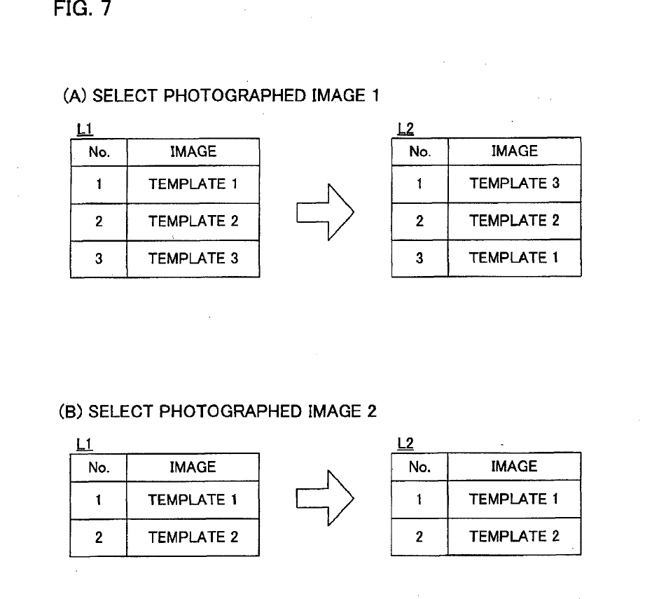

Therefore, when the photographed image shown in FIG. 5(A) is selected as the noticeable photographed image, the template images shown in FIG. 6(A) to FIG. 6(C) are extracted on the list L1 according to a manner shown in FIG. 7(A). On the other hand, when the photographed image shown in FIG. 5(B) is selected as the noticeable photographed image, the template images shown in FIG. 6(A) and FIG. 6(B) are extracted on the list L1 according to a manner shown in FIG. 7(B).

When the list L1 is completed, a transparent area frame that satisfies a size condition is selected out of the transparent area frames on the template image. The size condition is that under which a difference in size from the noticeable face frame is the smallest, and a transparent area frame having a size closest to that of the noticeable face frame is selected out of the transparent area frames on the template image. The selecting process of the transparent area frame based on such a size condition becomes meaningful when a plurality of transparent area frames are present on the template image.

Thereafter, the difference between the center coordinates of the selected transparent area frame and the center coordinates of the noticeable face frame on the noticeable photographed image is calculated for each of the template images on the list L1. In either of the photographed image or the template image, a coordinate origin is set to a center of the image, and the above-described difference is represented by a finite difference between a numerical value indicated by the center coordinates of the selected transparent area frame and a numerical value indicated by the center coordinates of the noticeable face frame. The calculated difference in center coordinates is defined as a “composition matching level”, and the more decreased the difference, the more increased the composition matching level.

It is noted that when the photographed image is rotated and developed in the work area 20f, die center coordinates of the face frame are converted in accordance with the rotation of the photographed image, and the converted center coordinates are referred for the calculation of the difference.

Upon completion of calculation of the composition matching level, the template images having the season setting are firstly moved to the list L2 in order of decreasing composition matching level. Upon completion of moving all the template images having the season setting, the template image not having the season setting is then moved to the list L2 in order of decreasing composition matching level.

Therefore, when the photographed image shown in FIG. 5(A) is selected, the template images shown in FIG. 6(A) to FIG. 6(C) are registered on the list 12 according to the manner shown in FIG. 7(A). Furthermore, when the photographed image shown in FIG. 5(B) is selected, the template images shown in FIG. 6(A) and FIG. 6(B) are registered on the list L2 according to the manner shown in FIG. 7(B).

Upon completion of the list 12, the template image registered at the top of the list L2 is reproduced according to the following manner. The CPU 32 detects the corresponding JPEG file from the flash memory 36, and writes the JPEG data accommodated in this JPEG file to a compressed-image area 20e of the SDRAM 20 through the memory control circuit 18. The CPU 32 further applies a decompression instruction to the JPEG codec 26. The JPEG codec 26 reads out the JPEG data accommodated in the compressed-image area 20e through the memory control circuit 18, performs JPEG decompression on the read-out JPEG data, and writes the decompressed image data to the decompressed-image area 20d of the SDRAM 20 through the memory control circuit 18.

Upon completion of reproducing the template image, a process for multiplexing the reproduced template image onto the noticeable photographed image (as a generic concept, a process for composing the reproduced template image and the noticeable photographed image) is executed on the work area 20f. Hereinafter, a template image to be multiplexed onto the noticeable photographed image is defined as a “noticeable template image”, and a transparent area frame satisfying the size condition, out of the transparent area frames on the noticeable template image, is defined as a “noticeable transparent area frame”.

When the multiplexing process is performed, a magnification of the noticeable photographed image and a multiplex position of the noticeable template image are adjusted such that the above-described composition marching level is increased, i.e., the center coordinates of the noticeable transparent area frame and the size thereof agree with the center coordinates of the noticeable face frame and the size thereof, respectively. Upon completion of the multiplexing process, one portion of the photographed image that sticks out from the outer edge of the template image is clipped, and thereby, the composite image is completed. The image data representing the completed composite image is then moved from the work area 20f to the decompressed-image area 20b. The moved image data is thereafter read out by the LCD driver 22, and as a result, the composite image is outputted from the LCD monitor 24.

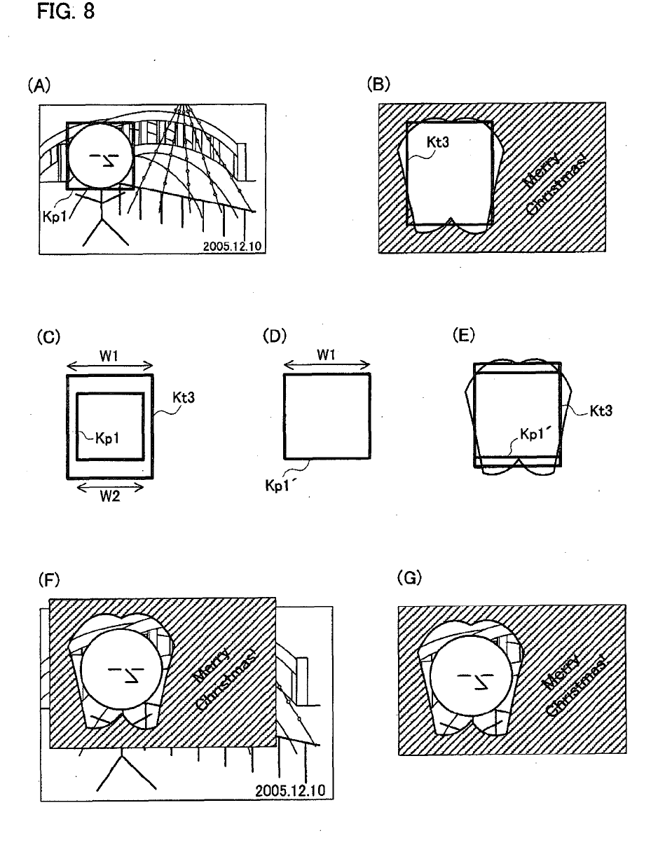

When the photographed image shown in FIG. 8(A) is selected as the noticeable photographed image and the template image shown in FIG. 8(B) is designated as the noticeable template image, a face frame Kp1 shown in FIG. 8(A) becomes the noticeable face frame, and a transparent area frame Kt3 shown in FIG. 8(B) becomes the noticeable transparent area frame.

A magnification of the noticeable photographed image is so adjusted that a horizontal size of the noticeable face frame Kp1 and a horizontal size of the noticeable transparent area frame Kt3 are coincident with each other, and the multiplex position of the noticeable template image is so adjusted that center coordinates of the noticeable transparent area frame Kt3 and center coordinates of a noticeable face frame Kp1′ having an adjusted magnification are coincident with each other (see FIG. 8(C) to FIG. 8(E)). With respect to the size adjustment the noticeable face frame Kp1′ has a horizontal size of “W1”, where “W2” denotes a horizontal size of the noticeable face frame Kp1 and “W1” denotes a horizontal size of the noticeable transparent area frame Kt3. The noticeable template image is multiplexed onto the noticeable photographed image having the adjusted magnification according to a manner shown in FIG. 8(F). Upon completion of the multiplexing process, one portion of the noticeable photographed image that sticks out from the outer edge of the noticeable template image is clipped, and thereby, a composite image shown in FIG. 8(G) is completed.

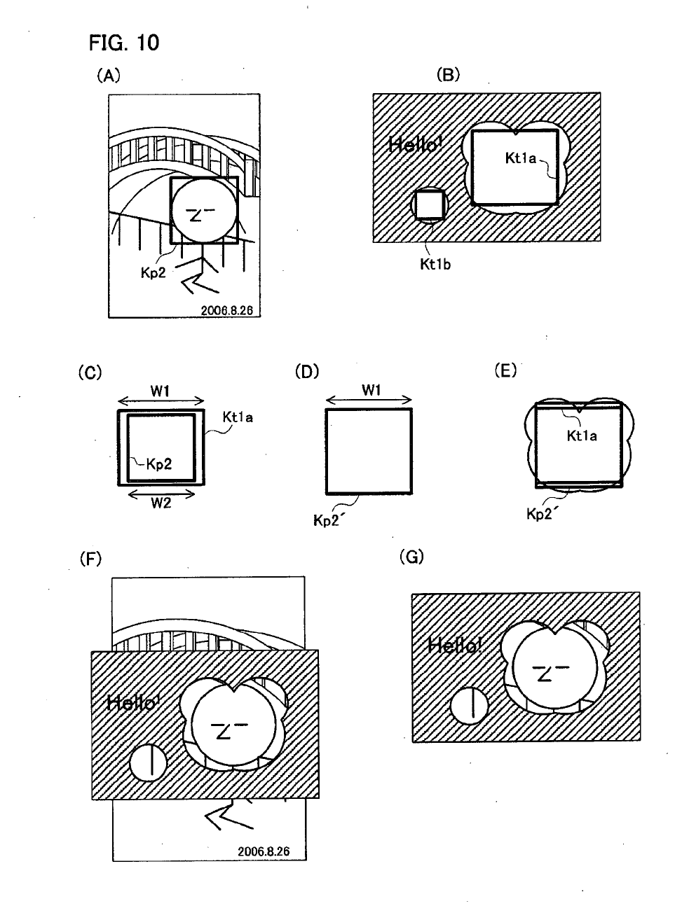

On the other hand, when a photographed image shown in FIG. 10(A) is selected as the noticeable photographed image and a template image shown in FIG. 10(B) is selected as the noticeable template image, a face frame Kp2 shown in FIG. 10(A) becomes the noticeable face frame and a transparent area frame Kt1a shown in FIG. 10(B) becomes the noticeable transparent area frame.

A magnification of the noticeable photographed image is so adjusted that a horizontal size of the noticeable face frame Kp2 and a horizontal size of the noticeable transparent area frame Kt1a are coincident with each other, and a multiplex position of the noticeable template image is so adjusted that center coordinates of the transparent area frame Kt1a and center coordinates of a noticeable face frame Kp2′ having an adjusted magnification are coincident with each other (see FIG. 10(C) to FIG. 10(E)). With respect to the size adjustment, the noticeable face frame Kp2′ has a horizontal size of “W1”, where “W2” denotes a horizontal size of the noticeable face frame Kp2 and “W1” denotes a horizontal size of the noticeable transparent area frame Kt1a. The noticeable template image is multiplexed onto the photographed image having the adjusted magnification according to a manner shown in FIG. 10(F). Upon completion of the multiplexing process, one portion of the noticeable photographed image that sticks out from the outer edge of the noticeable template image is clipped, and thereby, a composite image is completed (see FIG. 10(G)).

When a position correcting operation is performed by the key input device 38 after the composition image is completed, the multiplex position of the noticeable template image is corrected. The noticeable template image is multiplexed onto the noticeable photographed image again at the corrected multiplex position, so that the composite image thereby obtained is outputted from the LCD monitor 24 according to the same manner as that described above. Furthermore, in consideration of the multiplexing process to be performed on another noticeable template image updated by a template image updating operation, a multiplex position correction amount is normalized according to equations 1 and 2. According to the equation 1, a normalized multiplex position correction amount in the horizontal direction is calculated, and according to the equation 2, a normalized multiplex position correction amount in a vertical direction is calculated. It is noted that Hsize shown in the equation 1 and an equation 3 described later is equivalent to “W1” in the example shown in FIG. 8(C) or FIG. 10(C).

NChp=Chp/Hsize [Equation 1]

NChp: normalized multiplex position correction amount in the horizontal direction
Chp: multiplex position correction amount in the horizontal direction
Hsize: horizontal size of the transparent area frame

NCvp=Cvp/Vsize [Equation 2]

NCvp: normalized multiplex position correction amount in the vertical direction
Cvp: multiplex position correction amount in the vertical direction
Vsize: vertical size of the transparent area frame

Furthermore, when a magnification correcting operation is performed by the key input device 38 after the composite image is completed, the magnification of the noticeable photographed image is corrected. The noticeable template image is multiplexed again on a noticeable photographed image having a corrected magnification, so that a composite image thereby obtained is also outputted from the LCD monitor 24 avoiding to the same manner as that described above. In addition, in consideration of the multiplexing process to be performed on another noticeable template image updated by the template image updating operation, a magnification correction amount is normalized according to the equation 3.

NCmg=Cmg/Hsize [Equation 3]

NCmg: normalized magnification correction amount
Cmg: magnification correction amount
Hsize: horizontal size of the transparent area frame

When the template image updating operation is performed, a subsequent template image on the list L2 is designated as the noticeable template image, and reproduced according to the manner described above. The magnification of the noticeable photographed image and the multiplex position of the updated noticeable template image are so adjusted that the composition matching level is increased (so adjusted that the position and the size of the noticeable transparent area frame agree with the position and the size of the noticeable face frame, respectively), as described above.

In addition, the multiplex position of the updated noticeable template image is corrected with reference to the normalized position correction amounts calculated according to the equations 1 and 2. Furthermore, the magnification of the noticeable photographed image is corrected with reference to the normalized magnification correction amount calculated according to the equation 3.

When the horizontal size and the vertical size of the noticeable transparent area frame on the updated noticeable template image are defined as “Hsize” and “Vsize”, respectively, the multiplex position of the updated noticeable template image is moved in the horizontal direction by “NChp*Hsize” and in the vertical direction by “NCvp*Vsize” from the position so adjusted mat the composition matching level is increased. Furthermore, the magnification of the noticeable photographed image is a value obtained by multiplying the magnification so adjusted that the composition matching level is increased by “NCmg*Hsize”.

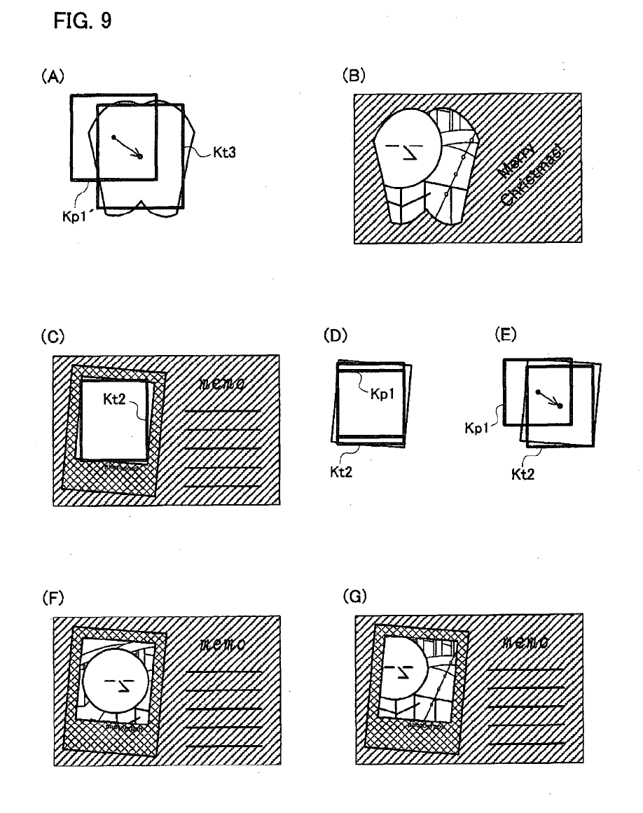

When the position correcting operation is performed after the composite image shown in FIG. 8(G) is completed, the multiplex position of the noticeable template image is corrected according to a manner shown in FIG. 9(A), for example, and thereby, a composite image shown in FIG. 9(B) is obtained.

When the template image updating operation is performed after the position correcting operation, a template image shown in FIG. 9(C) is regarded as a subsequent noticeable template image, and a transparent area frame Kt2 is regarded as a subsequent noticeable transparent area frame. The horizontal size of the noticeable transparent area frame Kt2 is coincident with the horizontal size of a noticeable face frame Kp1 (see FIG. 9(D)), and the magnification of the noticeable photographed image is set to “1.0”. Herein, the multiplex position of the noticeable template image is corrected with reference to the normalized position correction amounts calculated according to the equations 1 and 2 (see FIG. 9(E)).

As a result of performing of the multiplexing process that refers to the magnification and the multiplex position thus determined, a composite image shown in FIG. 9(G) is obtained. For reference, a composite image obtained when a position where the center coordinates of the noticeable transparent area frame Kt2 is coincident with the center coordinates of the noticeable face frame Kp1 is regarded as a multiplex position is shown FIG. 9(F).

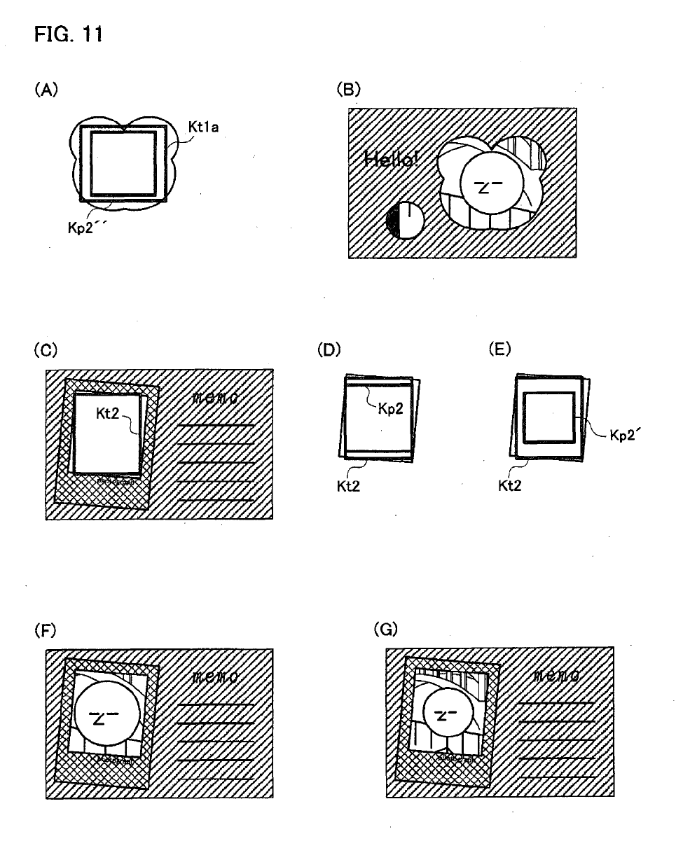

In addition, when the magnification correcting operation is performed after the composite image shown in FIG. 10(G) is completed, the magnification of the noticeable photographed image is corrected according to a manner shown in FIG. 11(A), and thereby, a composite image shown in FIG. 11(B) is obtained.

When the template image updating operation is performed after the magnification correcting operation is completed, a template image shown in FIG. 11(C) is designated as a subsequent noticeable template image, and a transparent area frame Kt2 is regarded as a subsequent noticeable transparent area frame. The horizontal size of the noticeable transparent area frame Kt2 is coincident with the horizontal size of a noticeable face frame Kp2 (see FIG. 11(C)), and the magnification of the noticeable photographed image is set to “1.0”. Herein, the magnification is corrected with reference to the normalized magnification correction amount calculated according to the equation 3 (see FIG. 11(E)).

As a result of performing of the multiplexing process that refers to the magnification and the multiplex position thus determined a composite image shown in FIG. 11(G) is obtained. For reference, a composite image obtained when the magnification of the noticeable photographed image is set to “1.0” is shown in FIG. 11(F).

When an image recording operation is performed on the key input device 38 after the composite image is completed the CPU 32 applies a compression instruction and a recording instruction to the JPEG codec 26 and the I/F circuit 28, respectively, in order to execute a recording process. The JPEG codec 26 performs JPEG compression on the composite image, according to the same manner as that described above, and writes JPEG data to the compressed-image area 20c of the SDRAM 20. The I/F circuit 28 reads out the JPEG data from the compressed-image area 20c through the memory control circuit 18, and creates a JPEG file containing the read-out JPEG data in the recording medium 30.

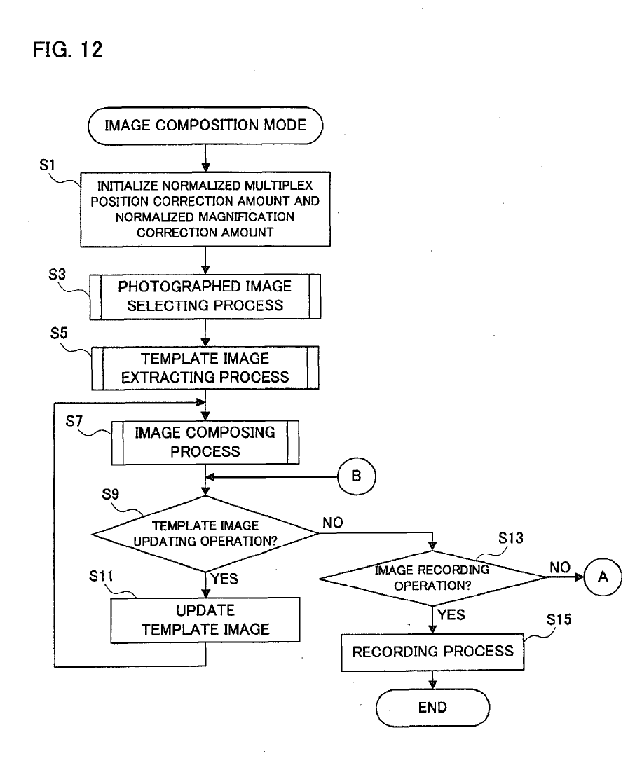

When an image composition mode is selected the CPU 32 executes a process according to flowcharts shown in FIG. 12 to FIG. 17. It is noted that a control program corresponding to these flowcharts is stored in the flash memory 36.

In a step S1, the normalized multiplex position correction amount and the normalized magnification correction amount are initialized. In a step 3, a photographed image selecting process is executed and in a step S5, a template image extracting process is executed. In the step S3, the photographed image having the face image is selected as the noticeable photographed image. Further, as a result of the process in the step S5, the lists L1 and L2 are created, and the template image registered at the top of the list 12 is designated as the noticeable template image. In a step S7, in order to compose the noticeable photographed image and the noticeable template image, an image composing process is executed.

In a step S9, it is determined whether or nor the template image updating operation is performed, and in a step S13, it is determined whether or not the image recording operation is performed. Further, in a step S17, it is determined whether or not the position correcting operation is performed, and in a step S23, it is determined whether or not the magnification correcting operation is performed.

When the template image updating operation is performed the process advances from the step S9 to a step S11 so as to update the noticeable template image to a subsequent template image on the list 12. Upon completion of the updating process, the process returns to the step S7. When the image recording operation is performed the process advances from the step S13 to a step S15 so as to execute the recording process. The composite image created by the image composing process in the step S7 is recorded in the recording medium 30 in a JPEG file format.

When the position correcting operation is performed the process advances from the step S17 to a step S19 so as to correct the multiplex. In a step S21, the normalized multiplex position correction amounts are calculated according to the above-described equation 1 and equation 2. Further, when the magnification correcting operation is performed the process advances from the step S23 to a step S25 so as to correct the magnification of the noticeable photographed image. In a step S27, the normalized magnification correction amount is calculated according to the above-described equation 3. Upon completion of the process in the step S21 or S23, the noticeable template image is multiplexed onto the noticeable photographed image again in a step S29. In the multiplexing process, the multiplex position corrected in the step S19 or the magnification corrected in the step S25 is referred. In a step S31, an unnecessary partial image (one portion of the noticeable photographed image that sticks out from the outer edge of the noticeable template image) is clipped. Upon completion of the process in the step S31, the process returns to the step S9.

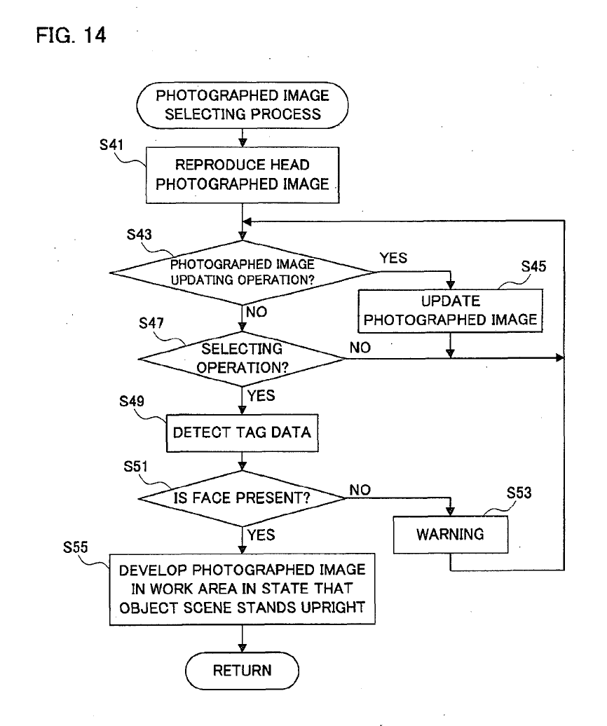

The photographed image selecting process in the step S3 shown in FIG. 12 is executed according to a subroutine shown in FIG. 14. Firstly, in a step S41, the JPEG file containing a head photographed image is reproduced from the recording medium 30. As a result, the head photographed image is displayed on the LCD monitor 24. In a step S43, it is determined whether or not the photographed image updating operation is performed, and in a step S45, it is determined whether or not the selecting operation is performed.

When the photographed image updating operation is performed the process advances from the step S43 to a step S45 so as to update the photographed image to be reproduced to a photographed image contained in a subsequent JPEG file. Upon completion of the updating process, the process returns to the step S43. When the selecting operation is performed the process advances from the step S47 to a step S49 so as to detect tag data from a JPEG file in which the selected photographed image is contained.

In a step S51, it is determined whether or not the face is present on the selected photographed image based on the tag data detected in the step S49. When NO is determined a warning is issued in a step S53, and then, the process returns to the step S43. When YES is determined the process advances to a step S55 so as to develop the photographed image in the work area 20f in a rotated state so that the object scene stands upright. The photographed image thus developed is the noticeable photographed image. Upon completion of the process in the step S55, the process is restored to a routine at a hierarchical upper level.

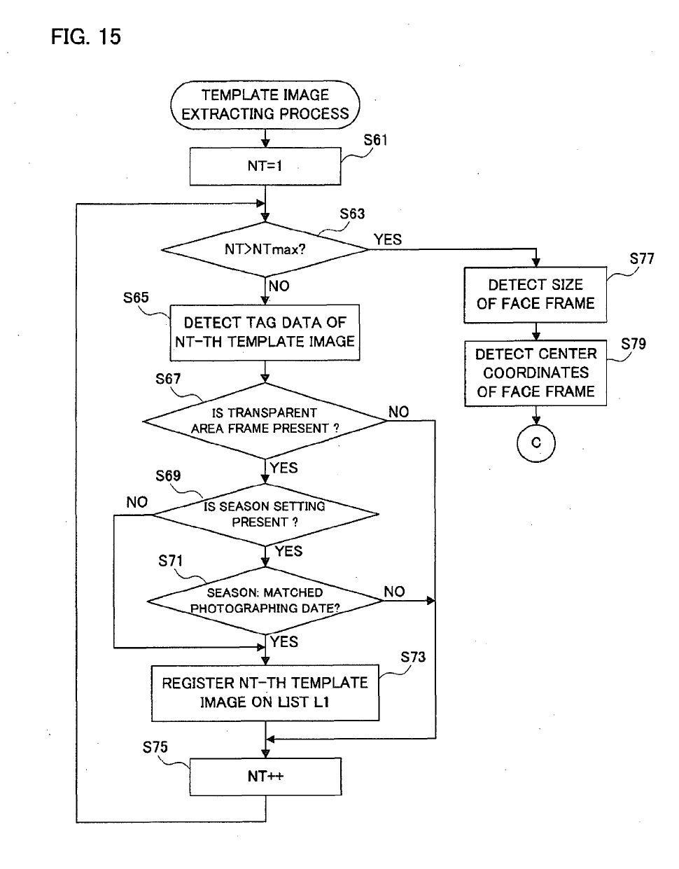

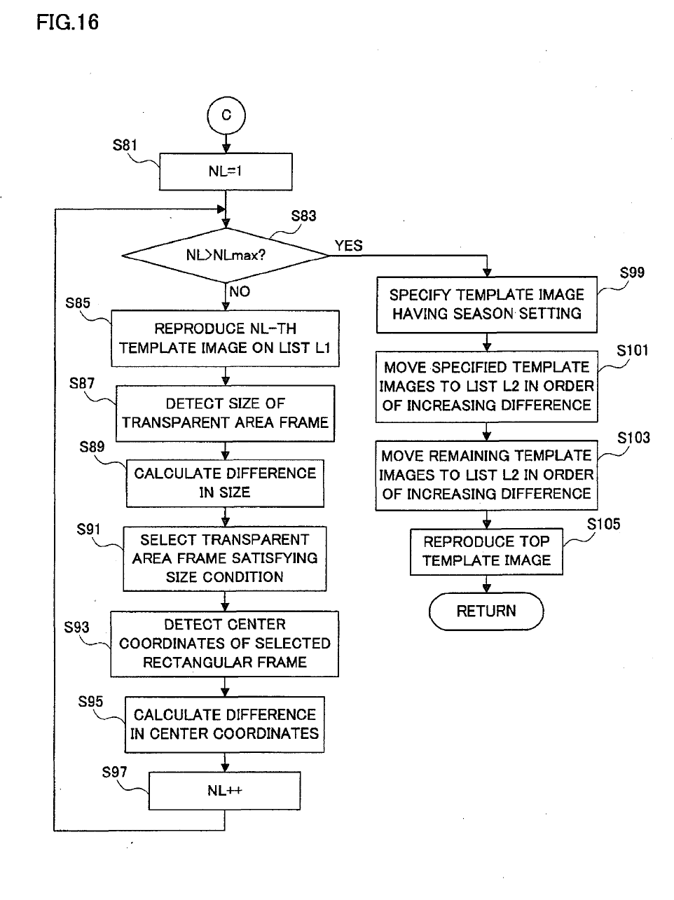

The template image updating process in the step S5 shown in FIG. 12 is executed according to a subroutine shown in FIG. 15 and FIG. 16. In a step S61, available NT is firstly set to “1”, and it is determined whether or not the variable NT exceeds a setting value NTmax. The setting value NTmax is equivalent to a total number of template images accommodated in the flash memory 36, and as long as NT≦NTmax is satisfied, the process advances to a step S65.

In the step S65, the tag data is detected from a JPEG file containing an NT-th template image. In a step S67, it is determined whether or not the transparent area frame is present based on the detected tag data, and in a step S69, it is determined whether or not the season setting is present based on the detected tag data.

When YES is determined in the both steps S67 and S69, it is determined in a step S71 whether or not the season of the NT-th template image matches the date of the noticeable photographed image. When YES is also determined in this step, the NT-th template image is registered on the list L1 in a step S73. When YES is determined in the step S67 while NO is determined in the step S69, the process advances to a step S73 without passing through the process in the step S71 so as to execute the above-described registering process.

Upon completion of the process in the step S73, the variable NT is incremented in a step S75, and then, the process returns to the step S63. When No is determined in the step S67 or step S71, the increment process is executed in the step S75 without passing through the process in the step S73, and then, the process returns to the step S63.

When YES is determined in the step S63, the horizontal/vertical sizes of the noticeable face frame are detected in a step S77, and the center coordinates of the noticeable face frame are detected in a step S79. The noticeable face frame is the primary face frame on the noticeable photographed image, and in the both steps S77 and S79, the tag data detected in the step S49 in FIG. 14 is referred. Alternatively, when the noticeable photographed image is the photographed image rotated on the work area 20f, values of the detected center coordinates are converted in consideration of the rotation.

In a step S81, the variable NL is set to “1”, and it is determined whether or not the variable NL exceeds the setting value NLmax. The setting value NLmax is equivalent to a total number of template images registered on the list L1, and as long as NL≦NLmax is satisfied, the process advances to a step S85. In the step, an NL-th template image on the list L1 is reproduced. The reproduced template image is secured in the decompressed-image area 20d.

In a step S87, the size of the transparent area frame on the reproduced template image is detected. In detecting the size, the tag data detected in the step S65 is referred. When a plurality of transparent area frames are present on the reproduced template image, all the sizes of the plurality of transparent area frames are detected. In a step S89, a difference between the size of the noticeable face frame detected in the step S77 and the size of the transparent area frame detected in the step S87 is calculated.

In a step S91, a transparent area frame that satisfies the size condition is selected out of the transparent area frames on the reproduced template image. As described above, the size condition is that under which a difference in size from the noticeable face frame is the smallest. Therefore, the process in the step S91 becomes meaningful when the plurality of transparent area frames are present on the template image, and a transparent area frame having a size closest to that of the noticeable face frame is selected out of a plurality of transparent area frames.

In a step S93, the center coordinates of the selected transparent area frame are detected. In a step S95, a difference between the center coordinates of the noticeable face frame and the center coordinates detected in the step S91 is calculated. Upon completion of the calculation process, the variable NL is incremented in a step S97, and then, the process returns to the step S83.

When NL>NLmax is established, the process advances from the step S83 to a step S99 so as to specify a template image having the season setting from the list L1. In a step S101, the specified template images are moved to the list L2 in order of increasing difference in center coordinates (in order of decreasing composition matching level). In a step S103, template images remaining on the list L1, i.e., template images without the season setting, are moved to the list L2 in order of increasing difference in center coordinates (in order of decreasing composition matching level). As a result, at the top of the list L2, a template image having the season setting and the smallest difference in center coordinates is registered and at the bottom of the list L2, a template image having no season setting and the largest difference in center coordinates is registered.

Upon completion of the List L2, the process advances to a step S105 so as to reproduce the template image at the top of the list L2. The reproduced template image is accommodated in the decompressed-image area 20d. Upon completion of the reproducing process, the process is restored to a routine at a hierarchical upper level.

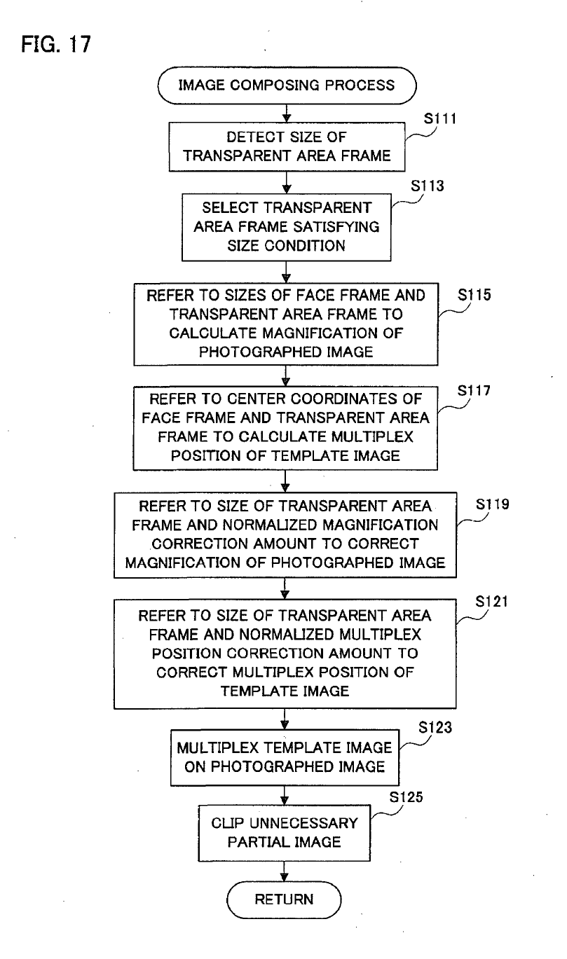

The image composing process in the step S5 shown in FIG. 12 is executed according to a subroutine shown in FIG. 17. Firstly, insteps S111 and S113, processes similar to those in the above-described steps S87 and S89 are executed on the noticeable template image. As a result, the noticeable transparent area frame is specified. In a step S115, a magnification of the noticeable photographed image in which the horizontal size of the noticeable face frame is coincident with the horizontal size of the noticeable transparent area frame is calculated. In a step S117, a multiplex position of the noticeable template image in which the center coordinates of the noticeable transparent area frame is coincident with the center coordinates of the noticeable face frame is calculated.

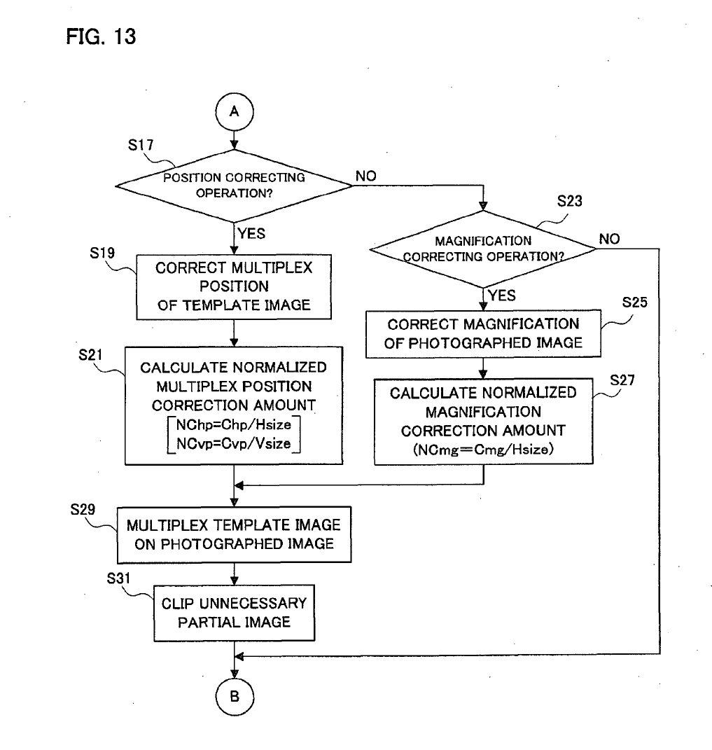

In a step S119, the magnification calculated in the step S115 is corrected by referencing the horizontal size of the noticeable transparent area frame and the normalized magnification correction amount calculated in the step S27 shown in FIG. 13. In a step S121, the multiplex position calculated in the step S117 is corrected by referencing the horizontal size of the noticeable transparent area frame and the normalized multiplex position correction amount calculated in the step S21 shown in FIG. 13.

In a step S123, the magnification corrected in the step S119 is referred to enlarge/reduce the noticeable photographed image, and the multiplex position corrected in the step S121 is referred so as to multiplex the noticeable template image onto the enlarged/reduced noticeable photographed image. In a step S125, one portion of the noticeable photographed image that sticks out from the outer edge of the noticeable template image is clipped. Upon completion of the composite image in this way, the process is restored to a routine at a hierarchical tipper level.

According to this embodiment, an attribute (attribute: the center coordinates and the size) of the transparent area frame (transparent area) provided in each of the plurality of template images (M of predetermined images) is detected by the CPU 32 (S87 to S93). The attribute of the face image (the specific object image) or that of the face frame (a specific object image area) provided in the photographed image is also detected by the CPU 32 (S77 and S79). The CPU 32 calculates each of the composition matching levels of the plurality of template images based on the detected attributes of the transparent area frame and the face frame (S95), and designates each of the plurality of template images in order of decreasing calculated composition matching level (S99 to S105, and S11). The CPU 32 further executes a process for multiplexing the designated template image onto the photographed image in such a manner as to improve the composition matching level (S111 to S123).

Thus, the composition matching level is calculated based on the attribute of the transparent area frame on the template image and the attribute of the face frame on the photographed image. The template image multiplexed onto the photographed image is designated in order of decreasing composition matching level, and the process for multiplexing the template image onto the photographed image is executed in such a manner as to improve the composition matching level. Thereby, a good composite image can be obtained.

It is noted that the attribute of the face frame (the specific object image area) is equivalent to one of the attributes of the face image (specific object image). That is, as a more specific concept of the attribute of the face image, the attribute of the face frame is present.

When thus embodiment is viewed from a different viewpoint, each of the attributes of the plurality of transparent area frames provided on the template image is detected by the CPU 32 (S87). The attribute of the face frame provided in the photographed image is also detected by the CPU 32 (S77). The CPU 32 calculates a difference between each of the plurality of attributes detected from the template image and the attribute detected from the photographed image (S89), and selects one of the plurality of transparent area frames based on the calculated difference (S91). The CPU 32 executes the process for multiplexing the template image onto the photographed image in such a manner that the difference between the attribute of the selected transparent area frame and the attribute of the face frame is inhibited (S111 to S123).

Thus, the transparent area frame to be noticed for the multiplexing process is selected based on the difference between each of the attributes of the plurality of transparent area frames and the attribute of the face frame. Further, the multiplexing process is executed in such a manner that the difference between the transparent area frame and the face frame is inhibited. Thereby, it becomes possible to satisfactorily compose the predetermined image having a plurality of transparent areas onto the photographed image.

When the embodiment is viewed from another different viewpoint the CPU 32 calculates composing process parameter (composing process parameter: the magnification of the photographed image and the multiplex position of the template image) based on the attribute of the face frame owned by the photographed image and the attribute of the transparent area frame provided on the template image (S115 and S117). The CPU 32 executes the process for multiplexing the template image onto the photographed image based on the calculated composing process parameter and normalized magnification/multiplex position correction amount (correction coefficient) (S117 to S123). The normalized magnification/multiplex position correction amount is updated by the CPU 32 in response to the magnification/position correcting operation after the completion of the multiplexing process (S27 and S21). The process for multiplexing the template image onto the photographed image is executed again in such a manner as to follow the magnification/position correcting operation (S29). The CPU 32 updates the template image when accepting the template image updating operation so as to restart the calculation process of the composing process parameter.

Therefore, the manner of the multiplexing process relies on the composing process parameter based on the attributes of the face frame and the transparent area frame and the normalized magnification/multiplex position correction amount. When the magnification/position correcting operation is performed, the manner of the multiplexing process is changed and also the normalized magnification/multiplex position correction amount is updated. When the template image updating operation is performed, the template image is updated, and the composing process parameter is calculated again. The manner of the multiplexing process using the updated template image relies on the newly calculated composing process parameter and the updated normalized magnification/multiplex position correction amount. As a result, the manner of the multiplexing process using the template image before the update is reflected on the multiplexing process using the template image after the update, and thereby, it becomes possible to satisfactorily compose the template image after the update onto the photographed image.

It is noted that in this embodiment, when a plurality of transparent area frames are present on the template image, a transparent area frame having a size of which the difference from the size of the face frame is the smallest is to be selected (S89 and S91). Further, when the template images are moved from the list L1 to the list L2, the selection is made in order of increasing difference between the center coordinates of the transparent area frame and the center coordinates of the face frame (S95, S101, and S103).

However, the transparent area frame having the center coordinates of which the difference from the center coordinates of the face frame is the smallest may be selected out of a plurality of transparent area frames on the template image, and may also be selected in order of increasing difference between the size of the transparent area frame and the size of the face frame when the template images are moved from the list L1 to the list 12.

It is noted that in this embodiment, upon allotting the order to the template images, the season set to the template image is taken into consideration (S69, and S99 to S103). However, it may be possible that instead of the season, time-of-year information such as a monthly event is set to the template image and the order is allotted to the template images while taking into consideration the set time of year. It is noted that in this case, the “time of year” is considered as a generic concept of the “season”.

Further, in this embodiment, the face image is assumed to be the specific object image. However, a succor ball, a flower, etc., may also be assumed to be the specific object image.

In addition, in this embodiment, at the time of the multiplexing process, the magnification adjustment is executed on the photographed image while the positional adjustment is executed on the template image. However, the positional adjustment may be executed on the photographed image.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image composing apparatus, comprising:
a first detector for detecting an attribute of a transparent area provided in each of M (M: an integer of equal to or more than two) of predetermined images;
a second detector for detecting an attribute of a specific object image provided in a photographed image;
a calculator for calculating a composition matching level equivalent to smallness of a difference between each of M of attributes detected by said first detector and the attribute detected by said second detector;
a designator for designating one of M of the predetermined images in order of decreasing composition matching level calculated by said calculator; and
a first composer for composing the predetermined image designated by said designator and the photographed image.

2. An image composing apparatus according to claim 1, wherein said first detector includes a first position detector for detecting a position of the transparent area as a portion of the attribute, said second detector includes a second position detector for detecting a position of the specific object image as a portion of the attribute, and said calculator increases the composition matching level as a difference between the position detected by said first position detector and the position detected by said second position detector is smaller.

3. An image composing apparatus according to claim 2, further comprising a rotator for rotating the photographed image so that a specific object stands upright, wherein said calculator notices a position of the specific object image after being rotated by said rotator.

4. An image composing apparatus according to claim 2, wherein each of M of the predetermined images has one or more transparent areas, said first detector further includes a first size detector for detecting each of sizes of the one or more transparent areas, as another portion of the attribute, and said first position detector executes a position detecting process for a transparent area having a size satisfying a size condition, out of the sizes detected by said first size detector.

5. An image composing apparatus according to claim 4, wherein said second detector further includes a second size detector for detecting a size of the specific object image, as another portion of the attribute, and the size condition includes a condition under which a difference from the size detected by said second detector is the smallest.

6. An image composing apparatus according to claim 1, further comprising:
an extractor for extracting a predetermined image having a time-of-year setting, out of N (N: an integer of equal to or more than M) of predetermined images; and
an excluder for excluding a predetermined image having a time-of-year setting not matching a date of the photographed image, out of the predetermined images extracted by said extractor, wherein the predetermined images remained after an excluding process of said excluder, out of N of the predetermined images, are equivalent to the M of the predetermined images.

7. An image composing apparatus according to claim 6, wherein said designator includes a first allocator for allocating an order according to the composition matching level to the predetermined image having a time-of-year setting, and a second allocator for allocating to the predetermined image not having a time-of-year setting an order according to the composition matching level and lower than the order allocated by the first allocator.

8. An image composing apparatus according to claim 1, wherein said designator includes an updater for updating the predetermined image composed by said first composer at each time an image updating operation is accepted.

9. An image composing apparatus according to claim 1, wherein said first composer includes a magnification adjuster for adjusting a magnification of the photographed image so that a size of the specific object image becomes close to a size of the transparent area, and a position adjuster for adjusting a composition position so that a position of the transparent area becomes close to a position of the specific object image.

10. An image composing apparatus according to claim 9, further comprising:
a first magnification corrector for correcting magnification of the photographed image in response to a magnification correcting operation;
a first position corrector for correcting the composition position in response to a position correcting operation; and
a second composer for composing again the predetermined image designated by said designator and the photographed image by referring to a correction result of said first magnification corrector and/or said first position corrector.

11. An image composing apparatus according to claim 10, further comprising a magnification correction amount normalizer for normalizing a magnification correction amount by said first magnification corrector based on a size of the transparent area on the predetermined image designated by said designator, wherein said first composer further includes a second magnification corrector for correcting the magnification of the photographed image based on the size of the transparent area on the predetermined image designated by said designator and the magnification correction amount normalized by said magnification correction amount normalizer.

12. An image composing apparatus according to claim 10, further comprising a position correction amount normalizer for normalizing the position correction amount by said first position corrector based on the size of the transparent area on the predetermined image designated by said designator, wherein said first composer further includes a second position corrector for correcting the composition position based on the size of the transparent area on the predetermined image designated by said designator and the position correction amount normalized by said position correction amount normalizer.

13. An image composing apparatus according to claim 1, further comprising a clipper for clipping one portion of the photographed image that sticks out from an outer edge of the predetermined image composed by said first composer.

14. An image composing apparatus according to claim 1, wherein the specific object image is equivalent to a face image.

15. An image composing apparatus according to claim 1, further comprising:
an acceptor for accepting an image selection operation for selecting the photographed image to be noticed by said first detector; and
an issuer for issuing a warning when the photographed image selected by the image selection operation does not have the specific object image.

16. An image composing apparatus according to claim 1, wherein said first composer executes a composing process in such a manner that the composition matching level calculated by said calculator increases.

17. An image composition program product executed by a processor of an image composing apparatus, said image composition program product, comprising:
a first detecting step of detecting an attribute of a transparent area provided in each of M (M: an integer of equal to or more than two) of predetermined images;
a second detecting step of detecting an attribute of a specific object image provided in a photographed image;
a calculating step of calculating a composition matching level equivalent to smallness of a difference between each of M of attributes detected by said first detecting step and the attribute detected by said second detecting step;
a designating step of designating one of M of the predetermined images in order of decreasing composition matching level calculated by said calculating step; and
a composing step of composing the predetermined image designated by said designating step and the photographed image.

18. An image composing method executed by an image composing apparatus, said image composing method, comprising:
a first detecting step of detecting an attribute of a transparent area provided in each of M (M: an integer of equal to or more than two) of predetermined images;
a second detecting step of detecting an attribute of a specific object image provided in a photographed image;
a calculating step of calculating a composition matching level equivalent to smallness of a difference between each of M of attributes detected by said first detecting step and the attribute detected by said second detecting step;
a designating step of designating one of M of the predetermined images in order of decreasing composition matching level calculated by said calculating step; and
a composing step of composing the predetermined image designated by said designating step and the photographed image.

19. An image composing apparatus, comprising:
a first detector for detecting an attribute of each of a plurality of transparent areas provided on a predetermined image;
a second detector for detecting an attribute of a specific object image provided in a photographed image;
a calculator for calculating a difference between each of the plurality of attributes detected by said first detector and the attribute detected by said second detector;
a selector for selecting one of the plurality of transparent areas based on the difference calculated by said calculator, and
a first composer for composing the predetermined image and the photographed image in such a manner that the difference between the attribute of the transparent area selected by said selector and the attribute of the specific object image is inhibited.

20. An image composing apparatus according to claim 19, wherein said selector selects a transparent area in which the difference is small.

21. An image composing apparatus according to claim 19, wherein said first detector detects, as the attribute, a size of each of the plurality of transparent areas, said second detector detects, as the attribute, a size of the specific object image, and said calculator calculates a difference between the size of each of the transparent areas and the size of the specific object image.

22. An image comprising apparatus according to claim 19, wherein said first composer includes a magnification adjustor for adjusting a magnification of the photographed image so that a size of the specific object image becomes close to a size of the transparent area, and a position adjustor for adjusting a composition position so that a position of the transparent area becomes close to a position of the specific object image.

23. An image composing apparatus according to claim 22, further comprising:
a first magnification corrector for correcting the magnification of the photographed image in response to a magnification correcting operation;
a first position corrector for correcting the composition position in response to a position correcting operation; and
a second composer for composing again the predetermined image designated by said designator and the photographed image by referring to a correction result of said first magnification corrector and/or said first position corrector.

24. An image composing apparatus according to claim 23, further comprising a magnification correction amount normalizer for normalizing a magnification correction amount by said first magnification corrector based on a size of the transparent area on the predetermined image designated by said designator, wherein said first multiplexer further includes a second magnification corrector for correcting the magnification of the photographed image based on the size of the transparent area on the predetermined image designated by said designator and the magnification correction amount normalized by said magnification correction amount normalizer.

25. An image composing apparatus according to claim 23, further comprising a position correction amount normalizer for normalizing the position correction amount by said first position corrector based on the size of the transparent area on the predetermined image designated by said designator, wherein said first multiplexer further includes a second position corrector for correcting the imposition position based on the size of the transparent area on the predetermined image designated by said designator and the position correction amount normalized by said position correction amount normalizer.

26. An image composing apparatus according to claim 19, further comprising a clipper for clipping one portion of the photographed image that sticks out from an outer edge of the predetermined image composed by said first composer.

27. An image composing apparatus according to claim 19, wherein the specific object image is equivalent to a face image.

28. An image composition program product executed by a processor of an image composing apparatus, said image composition program product, comprising:
a first detecting step of detecting an attribute of each of a plurality of transparent areas provided on a predetermined image;
a second detecting step of detecting an attribute of a specific object image provided in a photographed image;
a calculating step of calculating a difference between each of the plurality of attributes detected by said first detecting step and the attribute detected by said second detecting step;
a selecting step of selecting one of the plurality of transparent areas based on the difference calculated by said calculating step; and
a composing step of composing the predetermined image and the photographed image in such a manner that the difference between the attribute of the transparent area selected by said selector and the attribute of the specific object image is inhibited.

29. An image composing method executed by an image composing apparatus, said image composing method, comprising:
a first detecting step of detecting an attribute of each of a plurality of transparent areas provided on a predetermined image;
a second detecting step of detecting an attribute of a specific object image provided in a photographed image;
a calculating step of calculating a difference between each of the plurality of attributes detected by said first detecting step and the attribute detected by said second detecting step;
a selecting step of selecting one of the plurality of transparent areas based on the difference calculated by said calculating step; and
a composing step of composing the predetermined image and the photographed image in such a manner that the difference between the attribute of the transparent area selected by said selector and the attribute of the specific object image is inhibited.

30. An image composing apparatus, comprising:
a calculator for calculating a composing process parameter based on an attribute of a specific object image owned by a photographed image and an attribute of a transparent area provided on a predetermined image;
a first composer for composing the predetermined image and the photographed image based on the composing process parameter calculated by said calculator and a correction coefficient;
an updater for updating the correction coefficient in response to a correcting operation after a process of said first composer is completed;
a second composer for composing again the predetermined image and the photographed image in such a manner as to follow the correcting operation; and
a restarter for restarting said calculator by updating the predetermined image when an image updating operation is accepted.

31. An image composing apparatus according to claim 30, wherein said calculator calculates the composing process parameter so that a difference between the attribute of the transparent area and the attribute of the specific object image is inhibited.

32. An image composing apparatus according to claim 30, wherein said first composer includes a corrector for correcting the composing process parameter based on the correction coefficient.

33. An image composing apparatus according to claim 30, wherein said composing process parameter includes a magnification and a composition position of the photographed image, the correcting operation includes a magnification correcting operation for correcting the magnification and a composition position correcting operation for correcting the composition position, and the correction coefficient includes a magnification correction coefficient and a composition position correction coefficient.
